(19) United States
(12) Patent Application Publication
(10) Pub. No.: US 2016/0370166 A1
(43) Pub. Date: Dec. 22, 2016

(54) Method and Apparatus for Metal Thickness Measurement in Pipes with a Focused Magnetic Field

(71) Applicant: GOWell International, LLC, Houston, TX (US)

(72) Inventors: Jie Yang, Exton, PA (US); Qiuzhao Dong, Katy, TX (US)

(73) Assignee: GOWELL INTERNATIONAL, LLC, Houston, TX (US)

(21) Appl. No.: 14/745,879

(22) Filed: Jun. 22, 2015

(51) Int. Cl. G01B 7/06

(52) U.S. Cl. CPC G01B 7/10

(57) ABSTRACT

An apparatus and methods for inspecting pipes which may comprise a body attached to a tether for movement in a pipe. The body may comprises at least a transmitter coil and a receiver coil. The receiver coil may be disposed between at least two transmitter coils. The apparatus may also include a circuit for energizing the transmitter coil with a pulsed electromagnetic source and a circuit for receiving and processing a signal from the receiver coil. Methods include inserting an inspection device into a pipe and energizing transmitter coils. A magnetic flux is emitted from the transmitter coils. The method also includes inducing an eddy current within a pipe wall and measuring the electromagnetic flux induced in a receiver coil by the eddy current within the pipe wall.

### CROSS-REFERENCE TO RELATED APPLICATIONS

Not applicable.

STATEMENT REGARDING FEDERALLY SPONSORED RESEARCH OR DEVELOPMENT

Not applicable.

### BACKGROUND OF THE INVENTION

### Field of the Invention

This invention relates to the field of monitoring the integrity of tubing, casing, and piping using non-destructive means.

### Background of the Invention

Pipes may be used in many different applications and transport many types of fluids. Many times pipes are placed underground and/or positioned in an inaccessible area, making inspection of the pipes difficult. It may be beneficial to measure the thickness variations within a pipe while the pipe is in use. Previous methods for inspecting pipe have come in the form of non-destructive inspection tools such as electromagnetic devices that may measure magnetic flux-leakage within pipe. Electromagnetic devices may be well suited for pipe inspection because they may operate and be insensitive to any fluid within the pipe.

Previous devices and methods that may measure flux-leakage may only be useful for the detection of localized damage in ferromagnetic pipes. The measurement of flux-leakage may be hindered by the type of pipe, thinning of pipe, requirements of a strong magnetic field, strong flux coupling, and a requirement for the device to be in close proximity to the pipe walls. Additionally, electromagnetic tools that use eddy-current may be better suited for measuring the integrity of pipe. Drawbacks of a constant eddy-current electromagnetic tool may be that the signal from several frequencies may not be enough to penetrate a first wall of pipe and allow inspection of the integrity of a second wall of a larger surrounding pipe. Transient electromagnetic methods using pulsed electromagnetic waves may be limited to increasing the signals from a second pipe wall to additional pipe walls and may have problems optimizing a receiver coil and may suffer SNR problem. There is a need for an electromagnetic tool which may induce a larger amount of eddy-current within surrounding pipe walls.

### BRIEF SUMMARY OF SOME OF THE PREFERRED EMBODIMENTS

These and other needs in the art may be addressed in embodiments by an apparatus for inspecting pipes which may comprise a body attached to a tether for movement in a pipe. The body may comprise at least a transmitter coil and a receiver coil system, wherein the transmitter coil and receiver coil system may further include two transmitter coil and receiver coil pairs, with a soft-magnetic (i.e. air filled/non-magnetic non-conductive material) cylinder connecting the two pairs. The transmitter coil and receiver coil pairs may be collocated along the tool axial direction. In embodiments, two transmitter coils in a transmitter coil and receiver coil system may be energized in anti-direction/polarization state. Additionally, the receiver coil may be disposed between two transmitter coil and receiver coil systems. The apparatus may also include a circuit for energizing the transmitter coil with a pulsed electromagnetic source and a circuit for receiving and processing a signal from the receiver coil. These and other needs in the art may be addressed in further embodiments by a method for inspecting pipe. Methods include inserting an inspection device into a pipe and energizing transmitter coils. A magnetic flux is emitted from the transmitter coils. The method also includes inducing an eddy current within a pipe wall and measuring the electromagnetic flux induced in a receiver coil by the eddy current within the pipe wall.

In embodiments, a transmitter coil and receiver coil system may be energized by a pulsed source simultaneously with additional transmitter coil and receiver coil systems. When energized, the transmitter coil and receiver coil system may enter a stable state. A stable sate may be defined as the point when the magnetic fields produced may be constant or close to constant. Achieving a stable state, the energizing source may be quickly switched off, which may induce a strong eddy current in surrounding pipes. A receiver coil may detect and respond to the induced eddy currents within the pipe. The induced eddy current decay and diffusion within the pipes may be recorded as a change in time. The recorded signal magnitude over the change in time may be illustrated as a graphical curve. The graphical curve may be used to identify a pipes thickness, the pipes electromagnetic properties (metal conductivity and magnetic permeability), and geometrical configuration of pipes thereof. A receiver coil in a transmitter coil and receiver coil pair may be used to record a first pipes information. Using a small detecting aperture, which may be used for high resolution recording, a receiver coil may be able to detect thickness change with a pipe at about 1 ms. Additional receiver coils may be used to record information as to pipe thickness, electromagnetic properties, and geometrical configuration of outer pipes.

As described above, a detecting aperture in a receiver coil may be used to record pipe thickness, electromagnetic properties, and a pipes geometrical configuration. In embodiments, the detecting aperture may be increased or decreased by varying the current within the transmitter coil and receiver coil system. Reducing the aperture may help in remove bias and reduce the effect of remnant magnetization from adjacent pipes. Removal of bias and remnant magnetization may produce a more reliable readings as to the pipe thickness, electromagnetic properties, and geometrical configuration of pipes.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an inspection device disposed downhole;

FIG. 2 illustrates an embodiment of a receiver coil and transmitter coil;

FIG. 3 illustrates an embodiment of a transmitter coil;

FIG. 4 illustrates an embodiment of a magnetic flux density produced by a transmission coil without a soft magnetic core;

FIG. 5 illustrates an embodiment of a magnetic flux density produced by a transmission coil with a soft magnetic core;

FIG. 6 illustrates a graph comparing induced eddy current in a first and second pipe;

FIG. 7 illustrates a graph comparing the received signal differences between a first pipe and a second pipe;

FIG. 8 illustrates a graph comparing the received signal difference between a second pipe and a third pipe;

FIG. 9 illustrates a graph of a received signal from two identical transmitter coils, each with different current;

FIG. 10 illustrates a graph showing the signal received from a small defect in a first pipe using a single receiver and transmitter coils; and

FIG. 11 illustrates the receiver coil, transmitter coils, and small defect graphed in FIG. 10.

### DETAILED DESCRIPTION OF THE PREFERRED EMBODIMENTS

The present disclosure relates to embodiments of a device and method for inspecting the integrity of a pipe. More particularly, embodiments of a device and method are disclosed for inspecting the integrity of a number of pipe walls surrounding an innermost pipe wall. In embodiments, an inspection device may induce an eddy current in surrounding pipe walls, wherein a greater amount of eddy current may be induced in outer pipe walls. Eddy currents may be produced by energizing transmitter coils by a pulsed source and switching the source off in order to induce an eddy current in the surrounding pipe walls, wherein the receiver coils detect and record the magnetic flux produced by the induced eddy currents. The eddy current decay and diffusion in the pipe walls may be recorded, specifically recording signal magnitude in embodiments, which may produce a function of the pipe thickness and electromagnetic properties (e.g. metal conductivity and magnetic permeability) and the configurations of pipes. In embodiments, the power provided to different transmitter coils may be the same and/or different. Manipulation of the amount of current provided to different transmitter coils may move the detection aperture of the inspecting device, which may allow the inspection device to allow inspection of different sections along the pipe without moving and/or changing the eddy current distribution within the pipe.

In embodiments, an inspection device may be a pulsed electromagnetic thickness-detection tool. The inspection device may boost the signal ratio from outside pipes by creating an orthogonal, or close to orthogonal, magnetic field within the pipe string, which may provide a higher accuracy in outside pipe thickness measurement. The inspection device may be used to measure ferromagnetic pipe string thickness with remote field eddy current sensing and may include a tether for insertion into a pipe, having anti-alignment transmitter coil pairs and a plurality of receiver devices collocated/apart as the transmitter coil. In embodiments a circuit energizes the transmitter coil with a pulsed square wave, and a circuit receives a signal from each receiver device. Each transmitter and each receiver device may be a coil, centered or about centered on the longitudinal axis of the inspection device.

In further embodiments, the inspection device may include a first anti-alignment transmitter coil pair, which may induce an eddy current in the surrounding pipes, with relatively more eddy current in the outer pipes by guiding a magnetic field into the pipes. An anti-alignment transmitter coil pair may further be defined as a transmitter coil and receiver coil system. The transmitter coil and receiver coil system may include two transmitter coil and receiver coil pairs and a soft-magnetic (i.e., center air-filled/non-magnetic and non-conductive material) cylinder, connecting the two transmitter coil and receiver coil pairs. The transmitter coil and receiver coil pair may be collocated along the tool axial direction. In embodiments, a transmitter coil and/or a receiver coil may be energized in an anti-direction/polarization state. A transmitter coil pair with reversed directions may be spaced a distance from each other, which may increase an induced eddy current in pipes between the transmitter coil pair. In some embodiments, the length of two transmitter coils may be limited in order to produce a more orthogonal magnetic field. In further embodiments, a center-air cylindrical ferrite may be disposed as a core between two transmitters of a transmitter coil pair. Such disposition of the core may increase the orthogonal magnetic field. A long receiver coil may be located between the two transmitter pairs. In further embodiments, two short receivers may be collocated with two transmitter pairs. The inspection device may also dispose two additional long receivers at the outside of two transmitter pairs.

In embodiments, the anti-alignment transmitter coil pair may be energized simultaneously by a pulsed source. The source may be switched off quickly, from about a micro-second to about a millisecond. In some embodiments, the source is switched off when the system is stable. A stable system may be defined as when inspection device 2 produces a magnetic field in pipes that may be constant. By switching off the source, a strong eddy current may be induced in surrounding pipes. The receiver coils may detect and respond to the induced eddy currents. Without limitation, the eddy currents may decay and diffuse in the pipes. The measured signal magnitude and curve pattern may be a function of the pipes thickness and the corresponding electromagnetic properties (i.e., metal conductivity and magnetic permeability) and configuration of pipes. The signal within a short receiver may contain a first ferromagnetic tubing information. In some embodiments, the short receiver may have a small detecting aperture for high resolution. The signal may also be used to detect non-magnetic tubing thickness changes. In embodiments, the acquisition range is formed about one millisecond to about 1000 ms, about 250 ms to about 750 ms, about 300 ms to about 500 ms, or about 500 ms to about 800 ms. The signal in a long receiver may contain substantially all pipe information. In further embodiments, the long receiver may have a higher ratio of the outer pipe information compared to that of the collocated transmitter and receiver set.

In an embodiment, the power in two anti-direction identical transmitter pairs may be the same and/or different. With the same power, the detection aperture of the long receiver may be located at the center of the two transmitter pairs. In embodiments, using unequal power to energize the two transmitter pairs, the detection aperture may be shifted to the transmitter pair with the strongest amount of power. In embodiments, if transmitter pair one is energized with stronger power than transmitter pair two, then the energized power may be reversed using the current direction, and the sum of two signals (magnitude) in the long receiver between two pairs may be proportional to the signal with equal power. In embodiments, data processing may provide additional information from different viewpoints. For example, subtracting the two signals (magnitude) may be zero if the thickness in the pipe has about no difference at two shifted detection apertures. Such subtraction is not zero when the thickness has a difference. It is to be understood that such difference may provide the information of the corrosion within the pipe based on the results of a reduced detection aperture. Additionally, unequal power in two transmitter pairs may be energy efficient and remove system bias with proportional addition of two signals in the long receiver and without losing any information in the short receiver. Unequal power from two transmitter pairs may also be achieved by varying the length and turns of a transmitter coil pair.

In embodiments, a third set of receiver coils may be positioned at the other ends of the two transmitter pairs. These receivers may be targeted to detect the thickness change in the outside pipe strings, since the induced eddy current in the pipe string may have a different maximum location and which may vary with time. The induced eddy current may have a nearest maximum location to the transmitter in the innermost pipe and further to the transmitter in the outside pipe.

The receiver may be designed to receive the small signal with optimum core material, length, and turns. Moreover, effect from a transmitter coil may be minimized after switching off the power.

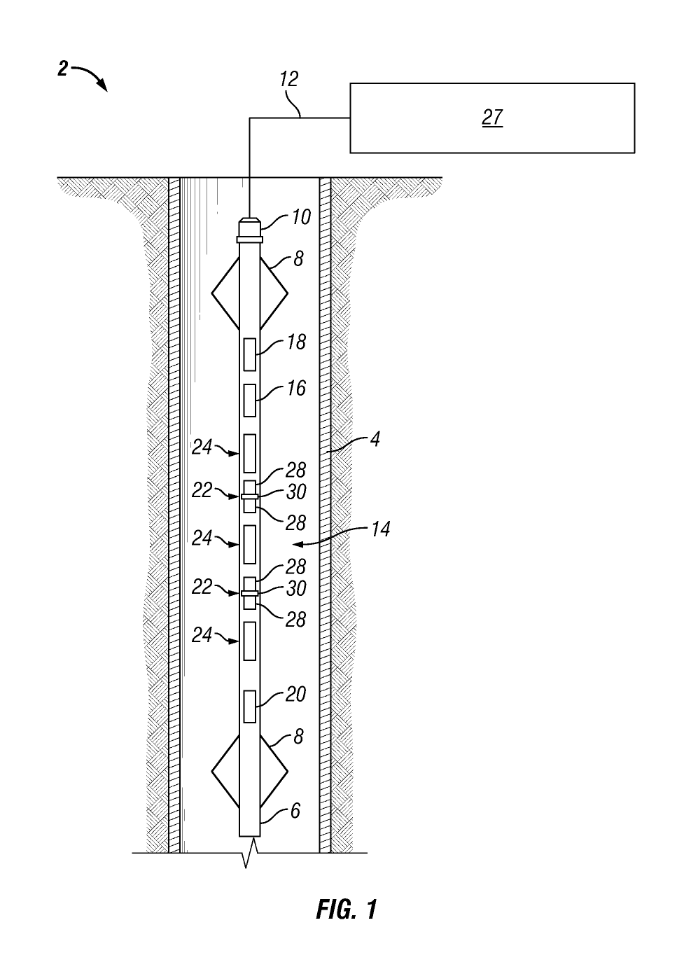

As illustrated in FIG. 1, an inspection device 2 may be inserted into a pipe 4. Inspection device 2 may be designed to detect defects and measure wall thickness about simultaneously in tubing and surrounding pipe. In embodiments, inspection device 2 may be able to detect and locate transverse and longitudinal defects (both internal and external) and determine the deviation of the wall thickness from its nominal value thorough the interpretation of voltage data. Pipe 4 may be made of any suitable material in which to house any suitable fluid. Suitable material may be, but is not limited to, metal, plastic, and/or any combination thereof. Additionally, any type of fluid may be contained within pipe 4 such as without limitation, water, hydrocarbons, and the like. In embodiments, there may be additional pipes which may encompass pipe 4. Inspection device 2 may comprise a housing 6, centralizers 8, and an adapter 10. Housing 6 may be any suitable length in which to protect and house the components of inspection device 2. In embodiments, housing 6 may be made of any suitable material to resist corrosion and/or deterioration from a fluid. Suitable material may be, but is not limited to, titanium, stainless steel, plastic, and/or any combination thereof. Housing 6 may be any suitable length in which to properly house the components of inspection device 2. A suitable length may be about one foot to about ten feet, about four feet to about eight feet, about five feet to about eight feet, or about three feet to about six feet. Additionally, housing 6 may have any suitable width. A suitable diameter may be about one foot to about three feet, about one inch to about three inches, about three inches to about six inches, about four inches to about eight inches, about six inches to about one foot, or about six inches to about two feet.

As further illustrated in FIG. 1, centralizers 8 may prevent inspection device 2 from coming into contact with pipe 4, such as by running into, hitting, and/or rubbing up against pipe 4. This may further increase data quality by preventing transverse vibrations of inner components while inspection device 2 is moving through pipe 4. In embodiments, there may be a plurality of centralizers 8. Centralizers 8 may be located at any suitable location along housing 6. A suitable location may be about an end of housing 6, about the center, and/or between the center and an end of housing 6. In embodiments as illustrated, a centralizer 8 may be disposed at about opposing ends of housing 6. Centralizers 8 may be made of any suitable material. Suitable material may be but is not limited to, stainless steel, titanium, metal, plastic, rubber, neoprene, and/or any combination thereof. In embodiments, the addition of springs, not illustrated, may further make up and/or be incorporated into centralizers 8.

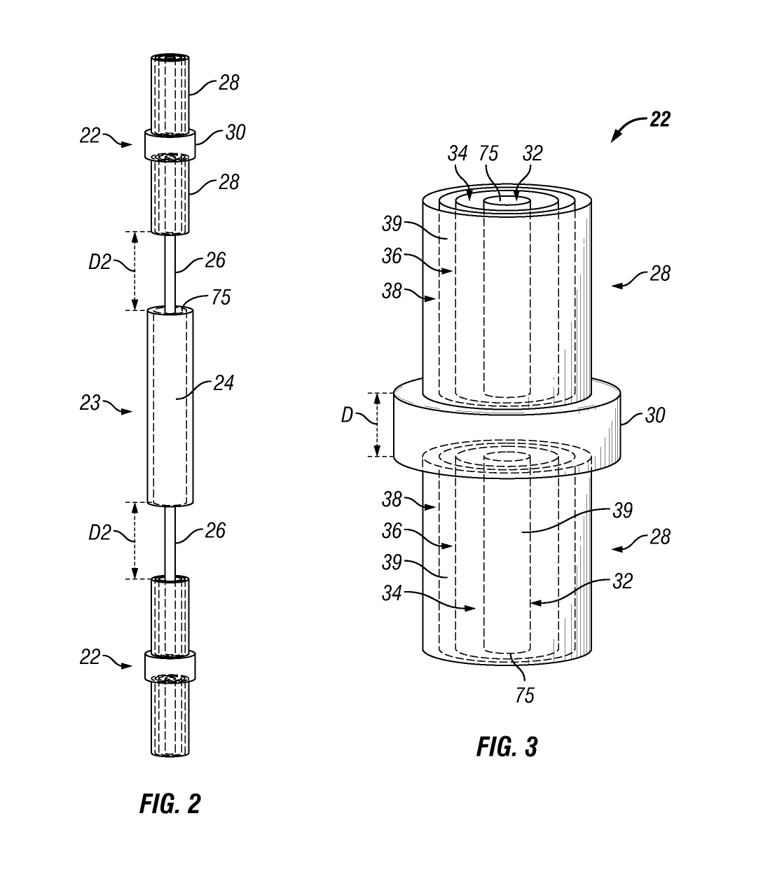

As illustrated in FIGS. 1 and 2, adapter 10 may be used to attach inspection device 2 to a tether 12, which may be attached to any suitable device. In some embodiment tether 12 is attached to a reel, not shown, which may lower and/or raise inspection device 2. Tether 12 may be a chain, rope, line, cable, and/or any combination thereof. Additionally, tether 12 may comprise a cable 26, which may allow recorded data to be transmitted there through to surface system 27. Cable 26 may extend through tether 12, adapter 10, and/or housing 6. Cable 26 may be any standard electrical cable, which may be used to transmit power and information between electronic devices. In embodiments, cable 26 may provide power to transmitter coils 22, receiver coils 24, electronic cartridge 16, memory unit 18, and/or temperature sensor 20. Adapter 10 may be made of the same or different material as housing 6. In embodiments, adapter 10 may be removed from housing 6 to allow access to the inner components of inspection device 2. Adapter 10 may attach to housing 6 by threading, adhesive, press fitting, nuts and bolts, screws, and/or any combination thereof. Adapter 10 may attach to tether 12 by any suitable means. Suitable means may be, but is not limited to, hooks, threading, adhesive, weld, press fitting, nuts and bolts, screws, carabiners, and/or any combination thereof. Adapter 10 may support inspection device 2 within pipe 4 and connect housing 6 to a surface device through tether 12. In embodiments, a surface system 27 may communicate and transmit power to inspection device 2 thorough tether 12.

As illustrated in FIG. 1, inner components of inspection device 2 may comprise a sonde 14, an electronic cartridge 16, a memory unit 18, and/or a temperature sensor 20. Sonde 14 may further comprise a transmitter coil 22 and a receiver coil 24. In embodiments, transmitter coil 22 may be an anti-alignment exciter-to-pick up coil. In embodiments, receiver coil 24 may be a long receiver coil. As illustrated in FIG. 1, in embodiments, inspection device 2 may include a plurality of transmitter coils 22 and a plurality of receiver coils 24 within sonde 14. In embodiments, a receiver coil 24 may be disposed between two transmitter coils 22, wherein the transmitter coils 22 may be above and below receiver coil 24. In further embodiments, as illustrated in FIG. 1, optional receiver coils 24 may be above and/or below transmitter coils 22. Transmitter coils 22 may be used to generate a focused eddy current in the walls of surrounding pipe 5 and measure the electromagnetic field induced by eddy current within the walls of pipe 4. Receiver coils 24 may measure the electromagnetic field of the induced eddy current after power has been switched off from the transmitter coils 22. In embodiments, receiver coil 24 and transmitter coil 22 are axially oriented. In some embodiments, receiver coil 24 and transmitter coil 22 each have their magnetic axis collocated along the longitudinal axis of inspection device 2.

FIG. 2 illustrates an embodiment of a transmitter receiver system 23. In embodiments, a plurality of receiver coils 24 and a plurality of transmitter coils 22 may be coaxially disposed along the axis of sonde 14 in any suitable order to allow for the induction and sensing of eddy currents. In embodiments, such disposition is optimized to allow for the largest possible induction and sensing of eddy currents. Transmitter coils 22 may attach to receiver coil 24 by cable 26. In embodiments, an aperture 75 may be disposed along the axial direction of core 32, which may allow for the disposition of wires and electronics within core 32.

In embodiments, electronic cartridge 16 may comprise a power supply board, which may provide voltage to areas of inspection device 2. Voltage may be supplied to a transmitter board, signal receiver board, and microcontroller/dsp board with adc. The transmitter board may control the transmitter coils and the signal receiver board may be used to control the receiver coils and/or windings. Additionally, the microcontroller/dsp board with adc may digitize analog signals, process data, and may control communications with surface system 27. Memory unit 18 provides in tool memory and may comprise flash chips and/or ram chips which may be used to store data and/or buffer data communication. Temperature sensor 20 may be any sensor suitable for measuring and for analyzing temperature.

FIG. 3 illustrates an embodiment of a transmitter coil 22, i.e. exciting coil. As illustrated in FIG. 3, transmitter coil 22 may be used to produce magnetic flux, which may be used to induce eddy currents within pipe 4. Transmitter coil 22 may comprise a plurality of coil sections 28 and a central core 30. Each coil section 28 may further comprise a core 32, separation material 34, receiver windings 36, and/or transmitter windings 38. In embodiments, core 32 may comprise any suitable material with a conductivity of zero or about zero. Suitable material may be, but is not limited to, a silicone and iron mixture, a cobalt and iron mixture, any soft magnetic iron metal, and/or any combination thereof. Core 32 may be any suitable length, such as about three inches to about six inches, about one foot to about three foot, about six inches to about twelve inches, or about six inches to about two feet. Additionally, core 32 may have a width of about half an inch to about three inches, about one inch to about four inches, about two inches to about six inches, or about six inches to about twelve inches. Core 32 may be separated from receiver windings 36 by separation material 34. In embodiments, transmitter coils 22 disposed within sonde 14 may be energized simultaneously but with different polarization. In embodiments, transmitter coils 22 may be manufactured to be identical structures, which may allow for the detection of defects and pipe wall thickness within pipe 4 easier.

As further illustrated in FIG. 3, embodiments include separation material 34 which may completely enclose the outer surface of core 32. In some embodiments (not shown), separation material 34 may only enclose the sides 39 of core 32. Separation material 34 may be made of any suitable material to substantially prevent the transfer of electricity from receiver windings 36 to core 32. Suitable separation material 34 may be, but is not limited to, fabric, glass, polymer, clay, and/or any combination thereof. In embodiments, receiver windings 36 may wind around core 32 any suitable number of times and may further be any suitable gauge of wire. Receiver windings 36 may be used to detect the eddy current transmitted into pipe 4 and/or pipe surrounding pipe 4.

In embodiments, illustrated in FIG. 3, transmitter windings 38 may wind around receiver windings 36 any suitable number of times and may further be the same gauge of wire as receiver windings 36. In embodiments, electric shield 39 is disposed between receiver windings 36 and transmitter windings 38. Transmitter windings 38 may be used to produce magnetic flux, which may then be used to produce a magnetic field. The magnetic field may then be used to induce an eddy current within the walls of pipe 4. In embodiments, not illustrated, transmitter windings 38 may be enclosed by separation material 34 and/or a housing. During operation, receiver windings 36 and transmitter windings 38 may be energized simultaneously but may have opposite polarization, which may generate a more radial-direction magnetic flux. A more radial-direction magnetic flux may travel further, which may allow inspection device 2 to induce eddy current within pipe walls outside of pipe 4.

As illustrated in FIG. 3, there may be two coil sections 28 disposed below and above central core 30. Central core 30 may be any suitable height. A suitable height may be about a quarter of an inch to about three inches, about one inch to about six inches, or about two inches to about four inches. Additionally, a suitable length of central core 30 may be about one inch to about three inches, about two inches to about four inches, about three inches to about six inches, about four inches to about eight inches, about five inches to about ten inches, or about six inches to about twelve inches. In embodiments, the length of central core 30 may be less than the length of core 32. Central core 30 may have an inside diameter about equaling or greater than the outside diameter of core 32, which may attract more magnetic flux flowing through radially. The length of central core 30 may be less than the length of core 32, wherein different lengths may be balanced between power consumption and radially produced magnetic flux. In embodiments, central core 30 and core 32 are cylindrical in shape. In embodiments, the outside diameter of central core 30 is not greater than the inside diameter of housing 6. In the embodiments, the length L of central core 30 is not greater than the distance D between the coil sections 28. Moreover, in embodiments, distance D between coil sections 28 is not greater than the length of a coil section 28.

In embodiments, the magnetic flux produced by transmitter coil 22 may be controlled by the distance D between coil sections 28 and central core 30. During operation, transmitter coils 22 may be energized simultaneously but with reversed polarization for the purpose of generating a more radial-direction magnetic flux, which may be able to induce an eddy current in pipe surround pipe 4. A ratio of l/r, wherein l is the length of core 32 and r is the radius of pipe 4, may be 3:2 or higher to produce more radial magnetic flux to induce eddy current within the walls of pipe surrounding pipe 4. In embodiments, the distance D2 between receiver coil 24 and a transmitter coil 22 is at least greater than half the length of the transmitter coil 22.

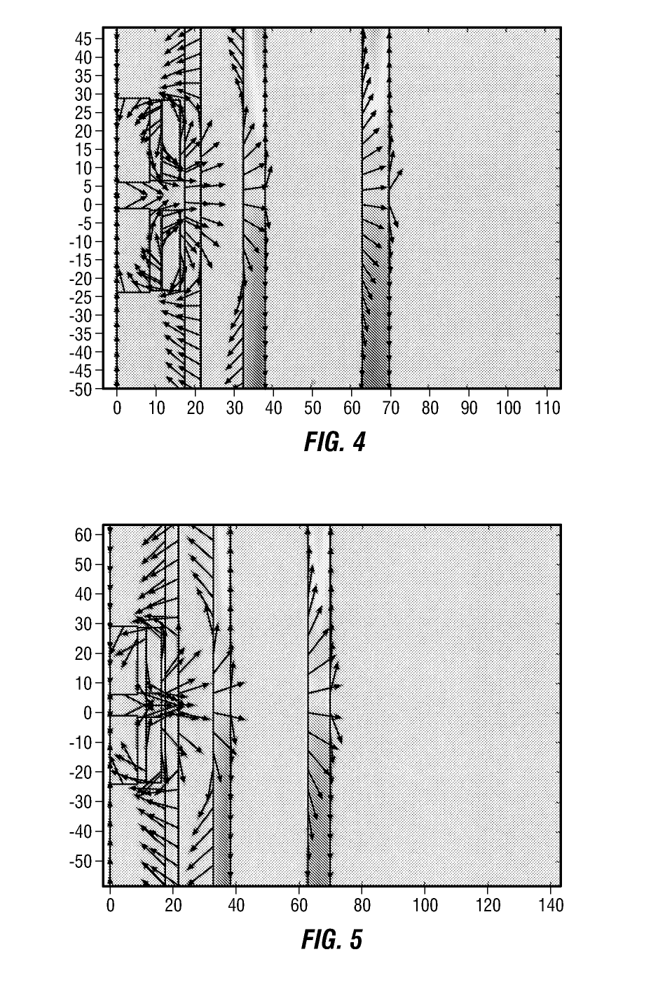

As illustrated in FIG. 4, a magnetic density 40 may be used to measure the strength of the magnetic flux produced by transmitter coil 22. During operation, transmitter coil 22 may produce magnetic flux, measured as magnetic density 40, which may be strong enough to penetrate pipe 4 and continue to produce a magnetic flux in second pipe wall 42 and third pipe wall 44. The magnetic flux within pipe 4, second pipe wall 42, and third pipe wall 44 may produce an eddy current within each of the pipe walls. The eddy current produced may be sensed and recorded by receiver coil 24.

Receiver coil 24, as illustrated in FIGS. 1 and 2, may be located between transmitter coils 22 and/or at the top and bottom of sonde 14. Receiver coil 24 may comprise a core, not illustrated, comprising the same low conductivity material as core 32. In embodiments, the core within receiver coil 24 may be comprised of nickel and iron, soft magnetic iron material, and/or any combination thereof. Receiver coil 24 may be designed to identify defects and/or density within pipe 4 and/or any additional pipes enclosing pipe 4. Additionally, receiver coil 24 may comprise a separation material and windings, not illustrated, to further the ability of receiver coil 24 to detect defects and/or density within pipe 4 and/or any additional pipes enclosing pipe 4.

A method of operation of inspection device 2 may be a continuously repeating method, which may be performed at various depths when moving through a zone of interest within pipe 5. Before measurements, inspections, and detection may take place, inspection device 2 may be first placed within pipe 4. Measurements, inspections, and detection may take place as inspection device 2 moves through pipe 4 in any direction. Travel time of inspection device 2 through a zone of interest within pipe 4 may depend on the duration of pulses and amplitude used to produce the magnetic flux within inspection device 2. Duration of a pulse may be set so that the signal variation between the excitation time and the “infinite” excitation time may be less than the noise constantly detected at signal level. Duration may vary based on the “electromagnetic” wall thickness of the inspected pipes. Electromagnetic wall thickness refers to the given conductivity σr and relative permeability μr with wall thickness d, wherein the wall thickness with conductivity σr and relative permeability μr is equal to d multiplied by the square root of ((μr σr)/μσ). A pulse generates magnetic flux within transmitter coils 22. Based on the distance between coils sections 28, within transmitter coil 22, the magnetic flux created by the pulse may be used to measure pipe 4 and/or pipes enclosing pipe 4. Additionally, the direction of the electric pulse through coil sections 28 may allow for inspection device 2 to detect different parts of pipe 4 and/or other encompassing pipes while inspection device 2 is inspecting pipe 4.

In embodiments, receiver coils 24 may be used to identify the defects and/or pipe thickness from pipe 4 and up to and past four additional pipes enclosing pipe 4. Receiver coils 24 may use a received difference signal ratio as defined in Equations (1) and (2) to detect defects and pipe wall thickness. As seen below:

R21=(V2−V1)/V2 (1)

R32=(V3−V2)/V3 (2)

where V2 is the received electromagnetic field from a second pipe, V1 is the received electromagnetic field from a first pipe, and V3 is the received electromagnetic field from a third pipe. R21 implies that the electromagnetic field weight from the second pipe, and R32 implies the electromagnetic field weight from the third pipe.

In embodiments, transmitter coils 22 may be energized simultaneously with an unequal power distribution. As illustrated in FIG. 3, and discussed above, there may be two coil sections 28 in each transmitter coil 22. One coil section 28 may be energized by current I1 and the second coil section 28 may be energized by current I2, a received signal from receiver coil 24 is defined as V1, after switching of the power. When energized, a received signal from receiver coil 24 is defined as V2. This may allow inspection device 2 to charge the change of V over a period of time using equations (3) and (4) below:

V=V1−V2 (3)

dV=(V1+V2)/(V1−V2) (4)

which illustrates that time-varying dV has the same decay tendency as the decay found in equal power excitation. In further embodiments, the V for unequal power as compared to Ve of equal power is written using equation (5). Equation (5) below:

V/Ve=(I1+I2)/(2I1) (5)

is used to compare the different types of V based on how coil sections 28 are energized.

Additionally, Equation (3) may remove system bias, which may be caused by inspection device 2 and/or the earth's magnetic field. Equation (3) may also be used to reduce the effect of remnant magnetization of magnetic pipe strings. Separately, Equation (4) may provide extra information from small defects in pipes which may result in reducing the detection aperture in pipes.

Energizing transmitter coils 22, a first current pulse with current magnitude I1 and corresponding duration time may be fed to a transmitter coil 22. A current pulse with current magnitude 12 may be fed to a corresponding transmitter coil 22 simultaneously. The electromagnetic field created by the transmitter coils 22 may magnetize pipe 4. This may induce an eddy current in pipe 4 and/or additional surrounding pipes. The eddy current induced may be recorded 1 ms or less after the end of the pulse through the transmitter coils 22 and saved as data 1. The acquisition time may range from 150 ms to 1000 ms, 150 ms to 500 ms, 250 ms to 750 ms, or 400 ms to 600 ms for individual receiver coils 24. A second pulse may then be sent through transmitter coils 22, repeating the process for recording data as data 2. Data 1 and data 2 may be processed within pipe 4 to remove bias and produce data 0, which may be saved into memory unit 18 and transmitted real time through cable 12 to surface system 27. The transmitting of magnetic flux and recording of eddy currents may continue repeatedly until the area of interest has been completely inspected by inspection device 2.

The measurement cycle may be repeated continuously at various depths while the tool is running through the pipe 4. Data transmitted to the surface system 27 may be processed in real time to have a direct sense for pipe 4 integrity. Saved memory data may be post-processed to obtain a more detailed and accurate view of pipe 4 integrity, such as magnetic permeability, electrical conductivity, pipe wall thickness and diameters, which may result in identifying defects and external and internal corrosion.

To further illustrate various embodiments of the present invention the following examples are provided.

FIGS. 4 and 5 illustrate the distribution of magnetic flux from a pair of transmitter coils shown in FIG. 11, wherein the transmitter coil is adjacent to a first tubing, which may preventing the magnetic flux from flowing to different pipes. The soft magnetic core in the gap between the pair of transmitter coils is used to attract more magnetic flux flowing, boosting the reach of the magnetic field. FIG. 4 illustrates the magnetic flux distribution without a magnetic core in the gap between the pair of transmitter coils. FIG. 5 illustrates the magnetic flux distribution with a magnetic core in the gap between the pair of transmitter coils. The arrows in the plots show magnetic flux direction, and the size of the arrow illustrates the density of the magnetic flux density. FIG. 5 demonstrates that the soft magnetic core between transmitter coils attracts and directs more magnetic flux than without a magnetic core. Larger amounts of directed magnetic flux may induce eddy current in additional layers of pipe. Further illustrated in FIGS. 4 and 5, the induced eddy current within the second pipe has increased due to the presence of a soft magnetic core, allowing for a receiver coil to better detect pipe thickness and properties. The y-axis illustrates vertical distance from the center of the soft magnetic core and the x-axis illustrates the horizontal distance from the center of the soft magnetic core.

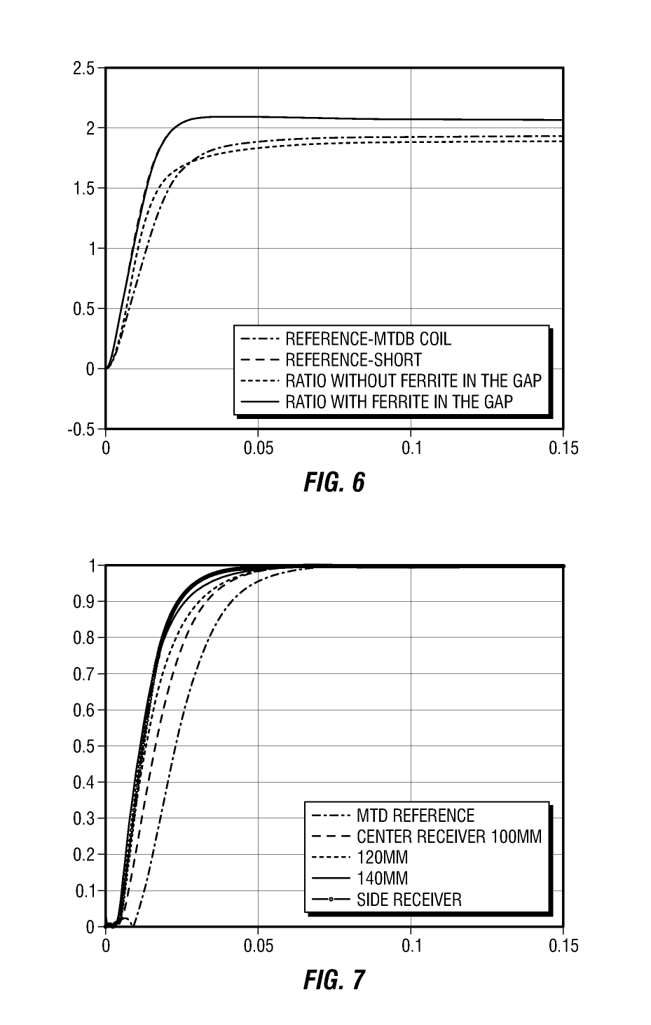

FIG. 6 illustrates the difference between an induced eddy current magnitude in a second pipe compared to an induced eddy current magnitude in a first pipe. As illustrated, transmitter coil pairs with a soft magnetic core connector have a higher amount of induced eddy current in the second pipe compared to transmitter coil pairs without a soft magnetic core connector. The y-axis illustrates the ratio of current in a second pipe to the current in a first pipe. The x-axis illustrates the measurement time of a receiver coil.

FIG. 7 illustrates recorded values of R21. Values are plotted comparing the signal difference between what a receiver coil records from a single pipe and what a receiver coil records from a second pipe. Increasing the distance between an upper transmitter and a lower transmitter creates a higher R21 value. The y-axis illustrates the normalized differential voltage, as found in the equation of (V2−V1)/V2. The x-axis illustrates the time recorded by a receiver coil.

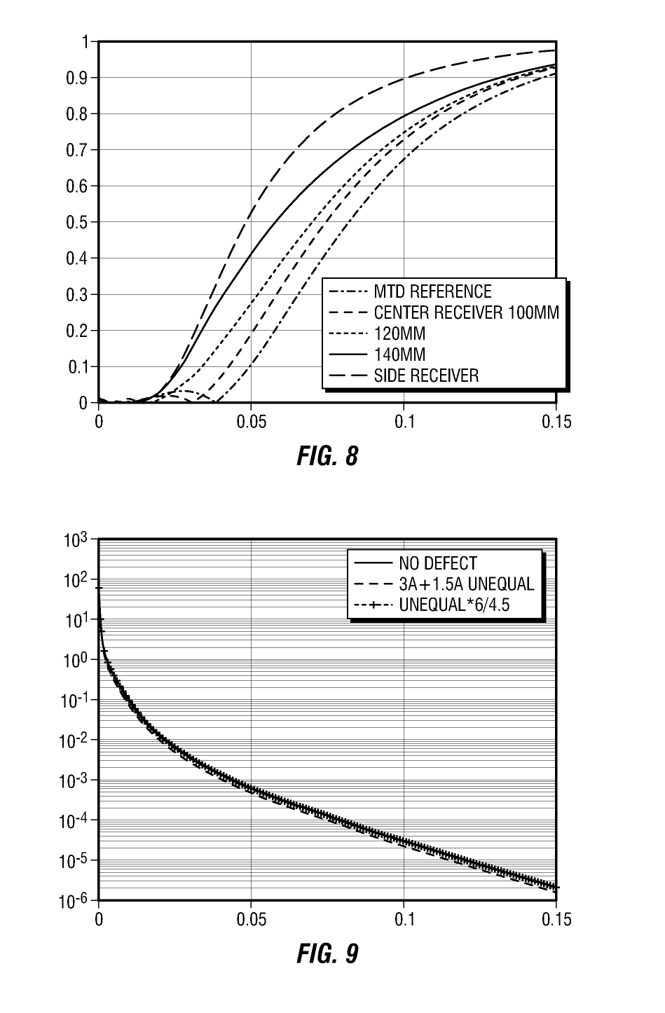

FIG. 8 illustrates the value of R32 as measured by the center and side receivers. As illustrated, the side receivers are able to record more information as to a third pipe thickness and properties. Increasing the distance between an upper and a lower transmitter coil will increase the R21 value, as discussed above. As illustrated in FIGS. 7 and 8, the values of R21 and R32 are easier to record with a side receiver and a larger gap between an upper and a lower transmitter coil. The y-axis illustrates the normalized differential voltage, as found in the equation of (V3−V2)/V3. The x-axis illustrates the time recorded by a receiver coil.

FIG. 9 illustrates within a graph the V produced from energizing transmitter coils with unequal current (current I1 and I2) as compared to the EMF Ve for equal power (current I1). The graph illustrates that the time-varying V has the same decay tendency as that the equal power excitation. It also illustrates that V1−V2 removes the system bias which may be caused by system and environmental earth magnetic field, which reduces the effect of remnant magnetization of magnetic pipe strings. The x-axis illustrates the voltage measured and the y-axis illustrates the measurement of time by the y-axis.

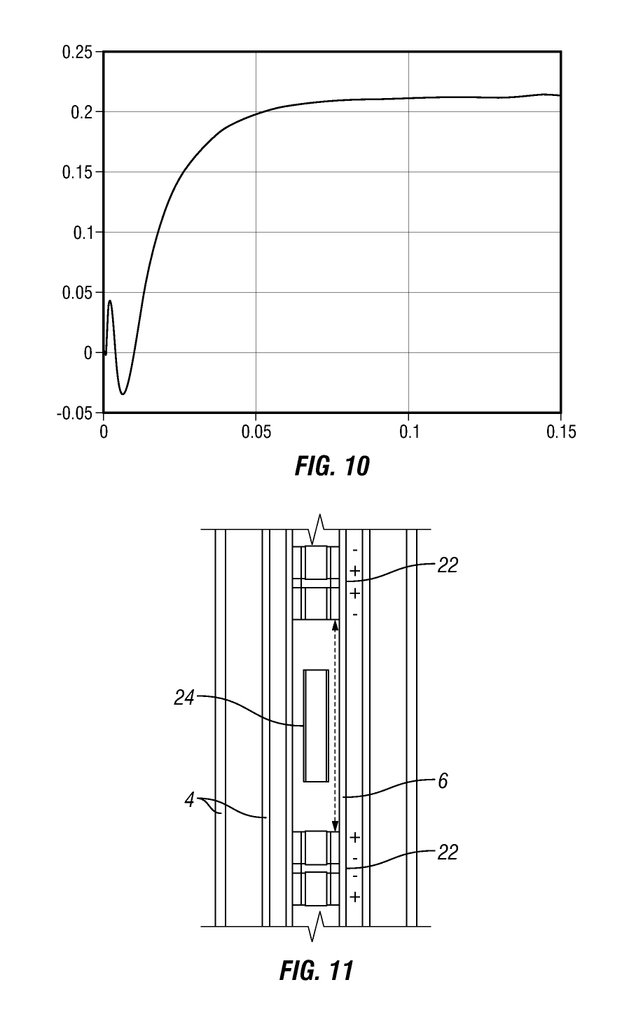

FIG. 10 illustrates the detection of a small defect 100 mm long, along tool axial direction, and disposed about center of a receiver coil to the center of a transmitter coils. The transmitter coils each had a different current within the two transmitter coils. The y-axis illustrates the results from equation (V(strong)−V(weak))/(V(strong)+V(weak)) and the x-axis illustrates the recording time by a receiver coil. FIG. 11 is a representation of the transmitter coils, receiver coil, and small defect detected in FIG. 10.

Although the present invention and its advantages have been described in detail, it should be understood that various changes, substitutions and alterations may be made herein without departing from the spirit and scope of the invention as defined by the appended claims.

1. A pipe inspection system, comprising:
a body attached to a tether for movement in a pipe, wherein the body comprises at least a transmitter coil and a receiver coil, wherein the receiver coil is disposed between at least two transmitter coils;
a device for energizing the transmitter coil with a pulsed electromagnetic source; and
a system for receiving and processing a signal from the receiver coil.

2. The system of claim 1, wherein the transmitter coil and receiver coil are axially oriented.

3. The system of claim 1, wherein the transmitter coil includes a plurality of coil sections and a core.

4. The system of claim 3, wherein the transmitter coil has a core, a separation material, a receiver winding, and a transmitter winding.

5. The system of claim 4, wherein the core comprises an aperture that extends lengthwise through the core.

6. The system of claim 4, wherein the core and central core have a conductivity of about zero.

7. The system of claim 1, wherein the transmitter coil has a central core disposed between coil sections, wherein each coil section comprises a core.

8. The system of claim 1, wherein the transmitter coils have different number of receiver windings or transmitter windings.

9. The system of claim 1, wherein at least one receiver coil is disposed above or below the transmitter coil.

10. The system of claim 1, further comprising an electronic cartridge, a memory unit, and a temperature sensor.

11. A method for inspecting pipe, comprising:
(A) inserting an inspection device into a pipe, wherein the inspection device comprises transmitter coils and a receiver coil;
(B) energizing transmitter coils, wherein a magnetic flux is emitted from the transmitter coils;
(C) inducing an eddy current within a pipe wall; and
(D) measuring electromagnetic flux induced in the receiver coil within the pipe wall.

12. The method of claim 11, further comprising repeating the method steps continuously while moving through a zone of interest.

13. The method of claim 11, wherein the inspection device comprises a housing, a plurality of stabilizers, and a sonde.

14. The method of claim 13, wherein the sonde comprises a plurality of receiver coils and a plurality of transmitter coils.

15. The method of claim 14, wherein the plurality of transmitter coils comprises a plurality of coil sections and a central core.

16. The method of claim 15, further comprising energizing the plurality of coil sections simultaneously.

17. The method of claim 11, further comprising energizing a first coil section before energizing a second coil section.

18. The method of claim 11, further comprising pulsing the transmitter coils.

19. The method of claim 18, further comprising sensing the eddy current by the receiver coil between pulsing the transmitter coils.

20. The method of claim 11, wherein receiver coils are disposed above and below the transmitter coils.
